(19) United States
(12) Patent Application Publication
(10) Pub. No.: US 2005/0232348 A1
(43) Pub. Date: Oct. 20, 2005

(54) Apparatus and method for error propagation reduction in a decision feedback equalizer

(75) Inventor: Chiao-Chih Chang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/107,468

(22) Filed: Apr. 15, 2005

Related U.S. Application Data
(60) Provisional application No. 60/562,485, filed on Apr. 15, 2004.

(51) Int. Cl. H04B 1/10

(52) U.S. Cl. 375/233; 375/350

(57) ABSTRACT

An error propagation reduction method is provided, for an equalizer comprising a forward equalizer and a decision feedback equalizer. First, an input signal is equalized to generate an equalized signal. The equalized signal is quantized to generate a quantized signal. The equalized signal is error decoded to generate a decoded signal. A value is calculated by linear combining the equalized signal, the quantized signal, and the decoded signal with weighting coefficients adaptable according to the channel quality. The value is used to set a register whose associated decision feedback equalizer coefficient has maximal magnitude. An apparatus performing the error propagation reduction is also provided.

The current application is supported by the previously applied provisional patent application No. 60/562485 filed on Apr. 15, 2004.

### BACKGROUND

The invention relates to an adaptive equalizer in digital communication systems and, in particular, to an apparatus and method for reducing error propagation in a decision feedback equalizer.

As is well known, in addition to being corrupted by noise, transmitted signal x(n) is also subject to channel distortion and distortion from multipath interference. Consequently, an adaptive equalizer is generally used in the receiver of a communication system to compensate for these effects. FIG. 1 shows a conventional adaptive equalizer diagram. The adaptive equalizer 100 comprises a forward equalizer (FE) 102, a decision feedback equalizer (DFE) 104, and an adder 108. An input signal r(n) is provided to the FE 102, and the output therefrom is added to the output from the DFE 104 in an adder 108 to generate an equalized signal q(n), where n denotes the time index. The decision unit 106 generates an decision signal d(n) based on the equalized signal q(n), which acts as an estimate of the original transmitted signal x(n) corresponding to the current equalized signal q(n). The decision signal d(n) is then fed back to the DFE 104. As an example, the decision unit 106 could be a “slicer”, which “slices” the equalized signal q(n) of the adaptive equalizer 100. The term “slice” refers to the process of taking the allowed symbol value that is nearest to that of the equalized signal q(n).

As shown in FIG. 1, the DFE 104 is an M-tap finite impulse response (FIR) filter comprises a plurality of registers 1042, a plurality of associated DFE coefficients 1044, a plurality of multipliers 1046, and a summing unit 1048, where M is a positive integer. Typically, these registers 1042 are shift registers. The decision signal d(n) is fed into the shift registers 1042. The i^{th} multiplier 1046 multiplies the value of the i^{th} shift register 1042, denoted by sᵢ, with the i^{th} DFE coefficient 1044, denoted by cᵢ. The summing unit 1048 sums up the output of each multiplier 1046. Similarly, the FE 102 is also a FIR filter having its own FE coefficients, shift registers, multipliers and the summing unit. The union of the FE coefficients and the DFE coefficients is referred to as the equalizer coefficients.

A concern that is common to the DFE is the phenomenon of error propagation. To understand this, please refer to FIG. 1 again. The FE 102 suppresses the precursor intersymbol interference (ISI), i.e., from symbols that are not yet detected, while the DFE 104 suppresses the postcursor ISI, i.e., from symbols that are already detected, using past decisions d(n). Hence, any erroneous past decision d(n) will result in residual postcursor ISI at the decision unit 106 that can possibly cause further decision errors, thus resulting in error propagation, which greatly downgrades equalizer's performance. The error propagation problem becomes even more severe if the transmission channel is a multipath channel.

In many applications, including digital television systems, the transmission channel is usually a multipath one containing sparsely separated echoes. In such case, the adaptive equalizer at the receiver side, after adaptation settling time, will have only a few non-zero valued equalizer coefficients, referred to as major coefficients, while most of the equalizer coefficients, referred to as minor coefficients, are close to zero. Typically, the magnitude of the major coefficient is much higher than that of the minor coefficient. It is those major coefficients that contribute most to channel echo attenuation in the operation of an equalizer.

FIG. 2 shows a channel response having two echoes within a specific echo distance (measured by time). Typically, the equalizer coefficients are recursively updated according to well-known LMS algorithm to approximate the channel response of the transmission channel. As a result, two major coefficients corresponding to the two echoes of the transmission channel are formed. The remaining equalizer coefficients are all minor coefficients having values much smaller than the major coefficients and are typically close to zero. As shown in the FIG. 2, the DFE coefficients 204 contain one major coefficient. Note that since the magnitude of the major coefficient is relatively high, once the decision signal stored in the shift register 1042 associated with the major coefficient is erroneous, their multiplication will introduce large incorrect postcursor ISI to the DFE output, which usually results in error propagation. It is desired to mitigate the error propagation in the DFE in order to ensure the performance of the adaptive equalizer.

### SUMMARY

An embodiment of the invention provides an error propagation reduction method for an equalizer comprising a forward equalizer and a decision feedback equalizer. First, an input signal is equalized to generate an equalized signal. The equalized signal is quantized to generate a quantized signal. The equalized signal is error decoded to generate a decoded signal. A value is calculated by linear combining the equalized signal, the quantized signal, and the decoded signal with weighting coefficients adaptable according to the channel quality. The value is used to set a register whose associated decision feedback equalizer coefficient has maximal magnitude. An apparatus performing the error propagation reduction is also provided.

Another embodiment of the invention provides an apparatus for reducing error propagation in a receiver. The apparatus comprises a forward equalizer, a decision feedback equalizer, an adder, a quantizer, an error correction decoder, and a calculating unit. The forward equalizer receives and stores an input signal in a first plurality of registers, and generates a first equalized signal based on the values stored in the first plurality of registers and a plurality of associated forward equalizer coefficients. The decision feedback equalizer generates a second equalized signal based on the values stored in a second plurality of registers and a plurality of associated decision feedback equalizer coefficients. The adder sums the first and second equalized signals to generate a third equalized signal. The quantizer receives the third equalized signal and produces a quantized signal. The error correction decoder receives the third equalized signal to produce a decoded signal. The calculating unit calculates a combined value for setting a register in the second plurality of registers whose associated decision feedback equalizer coefficient has maximal magnitude among the plurality of decision feedback equalizer coefficients. The combined value is obtained according to the third equalized signal, the quantized signal, and the decoded signal.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 shows a conventional adaptive equalizer;

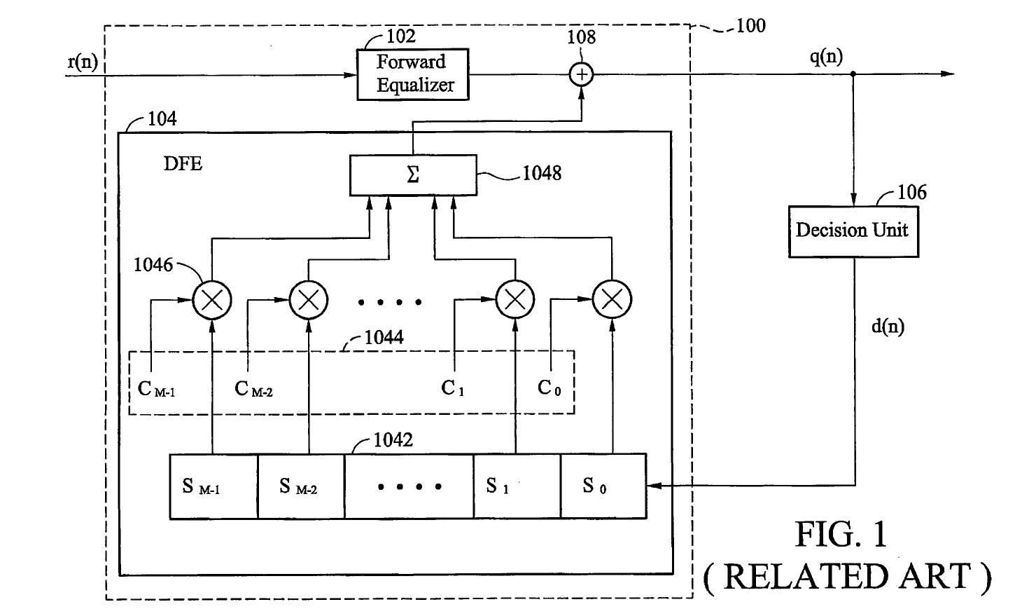

FIG. 2 shows a channel response having echoes within a specific echo distance (measured by time);

FIG. 3 illustrates an apparatus for reducing the error propagation according to an embodiment of the invention;

FIG. 4 shows the comparison among the reliability of the equalized signal q(n), the quantized signal d′(n), and the second decoded signal p′(n), respectively versus the channel quality;

FIG. 5 shows an embodiment of the calculating unit according to the invention;

FIG. 6 shows another embodiment of the calculating unit according to the invention; and

FIG. 7 is a flowchart of the method for reducing the error propagation in a decision feedback equalizer according to the embodiment of the invention.

### DETAILED DESCRIPTION OF THE INVENTION

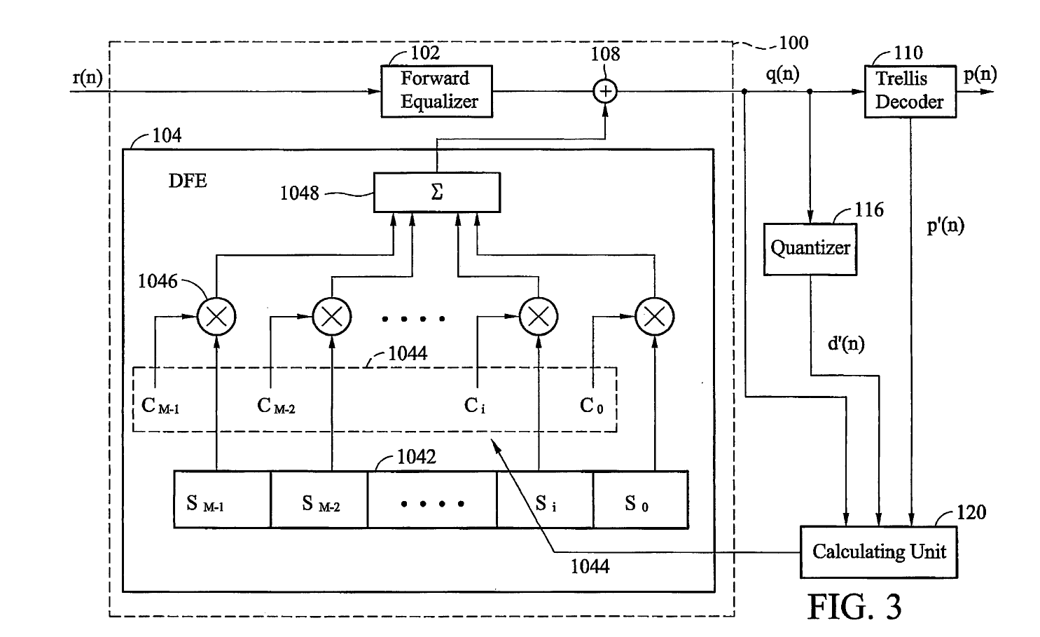

FIG. 3 illustrates an apparatus for reducing the error propagation according to an embodiment of the invention. The adaptive equalizer 100 is a conventional one comprising a FE 102, a DFE 104, and an adder 108. The adaptive equalizer 100 outputs an equalized signal denoted by q(n). A quantizer 116 is used to quantize the equalized signal q(n) to generate a quantized signal d′(n) having an improved reliability as compared with the equalized signal q(n). Here the “reliability” of a signal is a measure reflecting the confidence level to use the signal to represent the original transmitted signal x(n). The term “quantize” refers to the process of taking one of the preset symbol values that is nearest to that of the equalized signal q(n). The allowed symbol values in the system are a subset of the preset symbol values used in the quantizer 116. If the preset symbol values exactly equal to the allowed symbol values, the quantizer 116 becomes a conventional slicer.

The equalized signal q(n) is then subjected to trellis decoding, e.g. a Viterbi decoder, by a trellis decoder 110 to generate a first decoded signal p(n) and a second decoded signal p′(n). As is well known in the art, while performing the trellis-decoding algorithm, each candidate symbol at the present time n is associated with a survivor path. By tracing back the survivor path that having minimal path metric, the symbol at the time (n-H) is determined and outputted as the first decoded signal p(n), which is sent to the next stage (not shown) for further data processing. The H denotes the length of the survivor path and corresponds to the decoding delay. The larger the H is, the less the decoding error will be. Therefore, in order to effectively reduce the symbol error, the value of H used is typically a large number. However, a large H will also introduce long decoding delay, which makes the first decoded signal p(n) being too ‘old’ to be useful to the DFE 104. Instead of basing on these survivor paths of length H, a second decoded signal p′(n) is generated based on the survivor paths of length h, which is less than H. By this way, the decoding latency of the second decoded signal p′(n) is less than that of the first decoded signal p(n), while the reliability of the second decoded signal p′(n) is till higher than that of the decision signal d(n).

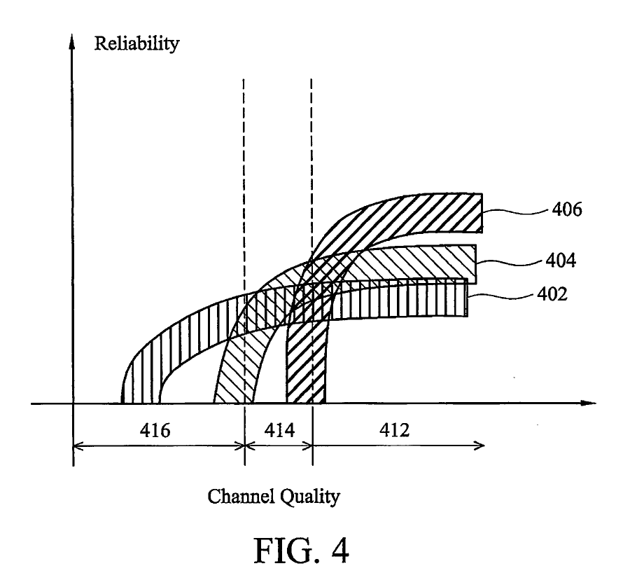

FIG. 4 shows the comparison among the reliability of the equalized signal q(n), the quantized signal d′(n), and the second decoded signal p′(n), respectively versus the channel quality. Note that the channel quality is not the only one factor affecting the reliability of a signal. All the possible reliability curves of the equalized signal q(n), the quantized signal d′(n), and the second decoded signal p′(n) form the regions 402, 404, and 406, respectively. It is apparent to one skilled in the art when the channel quality is high enough (the range 412); the trellis decoder 110 provides more reliable results than others due to the error coding gain. When the channel quality decreases, the performance of the error correction decoder 204 reduces rapidly, while the quantized signal d′(n) and the equalized signal q(n) still maintain fair reliability as the channel quality falls within the range 414. Once the channel quality is lower than a certain level (range 416), the reliability of the quantized signal d′(n) reduces rapidly, and only the equalized signal q(n) still maintain fair reliability. From FIG. 4, it can be found that by taking these three signals into account rather than just only one of them, the signal reliability can be improved.

The error propagation in the DFE 104 is highly related to these major ones of the DFE coefficients 1042, especially the one having the maximal magnitude. The error propagation can be reduced by increasing the reliability of the signal value, denoted by sᵢ, stored in an i^{th} shift register associated with the DFE coefficient, denoted by cᵢ, having the maximal magnitude. According to the present invention, a calculating unit 120, as shown in FIG. 3, is used to calculate a value s′ to be stored in the i^{th} shift register. The value s′ is obtained by linear combining the equalized signal, the quantized signal and the second decoded signal.

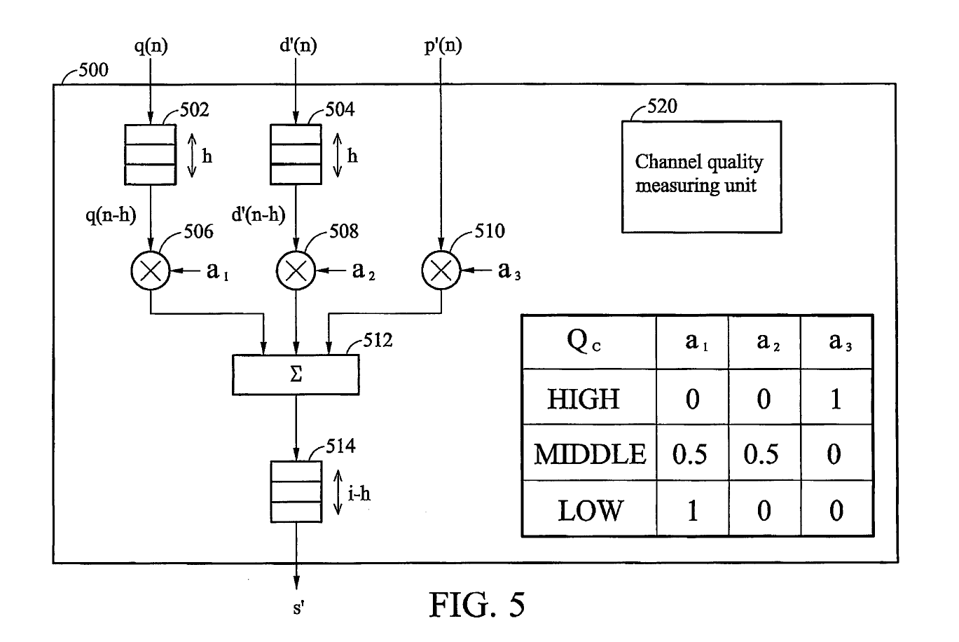

FIG. 5 shows an embodiment of the calculating unit according to the present invention for the case that the decoding latency h of the second decoded signal is less than the value of i. In this embodiment, the value s′ is obtained by linear combining the equalized signal q(n−i), the quantized signal d′(n−i) and the second decoded signal p′(n−i+h) , i.e.,
s′=a₁·q(n−i)+a₂·d′(n−i)+a₃·p′(n−i+h) (1)
where (a₁,a₂,a₃) are weighting coefficients, which are non-negative numbers having sum of 1. The calculating unit 500 in this embodiment comprises a first h-tap delay line 502, a second h-tap delay line 504, and three multipliers 506, 508, and 510, a summing unit 512, a (h-i)-tap delay line 514, and a channel quality measuring unit 520. The first h-tap delay line 502 receives and delays the equalized signal q(n) to obtain a delayed signal q(n-h). The second h-tap delay line 502 receives and delays the quantized signal d′(n) to obtain another delayed signal d′(n-h). These three signals q(n-h), d′(n-h), and s′(n) are linear combined with the weighting coefficients (a₁,a₂,a₃) through the multipliers 506, 508, and 510, and the summing unit 512. The output of the summing unit 512 is further delayed by the (h-i)-tap delay line 514 to form the s′ that will be used to set the value of the i^{th} shift register 1042 in the DFE 104.

The weighting coefficients (a₁,a₂,a₃), according to the present invention, are adaptable according to the channel quality indicator Q_{c} generated by a channel quality measuring unit 520 so as to improve the reliability of s′ and thereby reduce the error propagation. As an example, please also refer to FIG. 4, if the channel quality indicator Q_{c} is HIGH, let (a₁,a₂,a₃)=(0,0,1) since the second decoded signal p′(n) should have the best reliability. If the channel quality indicator Q_{c} is MIDDLE, let (a₁,a₂,a₃)=(0.5,0.5,0) since the reliability of the second decoded signal p′(n) becomes too poor to be used. If the channel quality indicator Q_{c} is LOW, let (a₁,a₂,a₃)=(1,0,0) since the equalized signal q(n) has the best reliability.

Note that when the i is less than the decoding latency h of the second decoded signal, the second decoded signal p′(n−i+h) will become invalid since it has not yet been generated. In such a case, the formula given in Eq. (1) for calculating the value s′ is degenerated to the form
s′=a₁·q(n−i)+a₂·d′(n−i) (2)

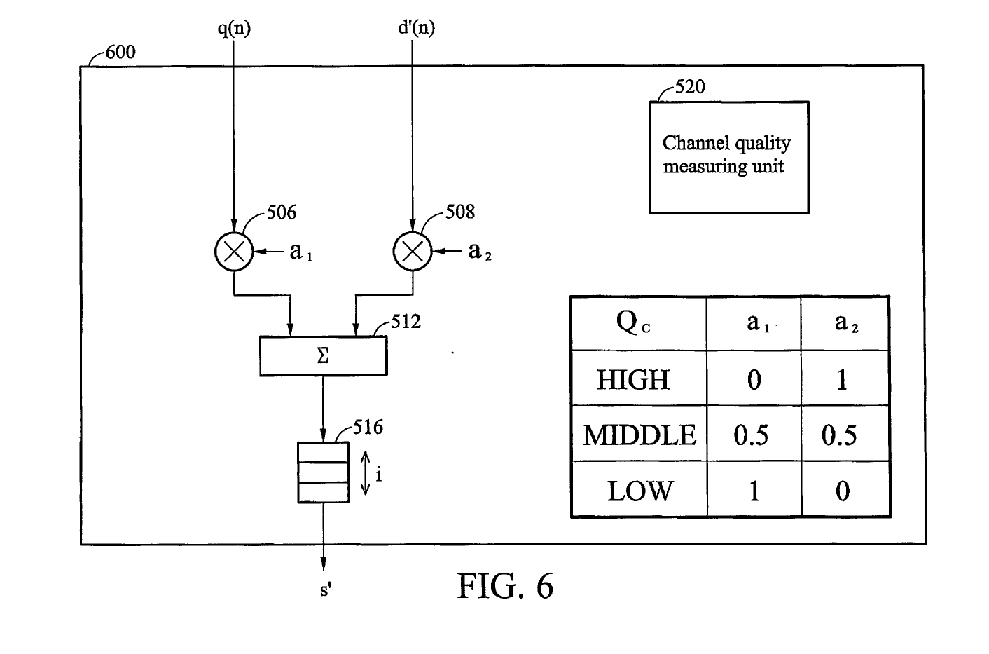

FIG. 6 shows another embodiment of the calculating unit according to the invention. In this case, the calculating unit 600 comprises two multipliers 506 and 508, a summing unit 512, an i-tap delay line 516, and a channel quality measuring unit 520. Only the signals q(n) and d′(n) are linear combined with the weighting coefficients (a₁,a₂) through the multipliers 506 and 508, and the summing unit 512. The output of the summing unit 512 is further delayed by the i-tap delay line 516 to form the s′ that will be used to set the value of the i^{th} shift register 1042 in the DFE 104.

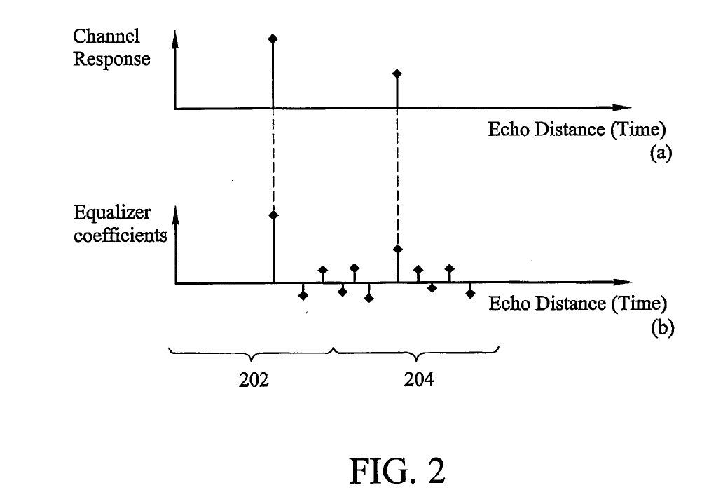

The weighting coefficients (a₁,a₂), according to the present invention, are adaptable according to the channel quality indicator Q_{c} generated by the channel quality measuring unit 520 so as to improve the reliability of s′ and thereby reduce the error propagation. As an example, please also refer to FIG. 4, if the channel quality indicator Q_{c} is HIGH, let (a₁,a₂)=(0,1) since the quantized signal d′(n) should have the better reliability than the equalized signal q(n). If the channel quality indicator Q_{c} is MIDDLE, let (a₁,a₂)=(0.5,0.5) since it is hard to tell which one will have better reliability so it would be a save way by averaging these two signals. If the channel quality indicator Q_{c} is LOW, let (a₁,a₂)=(1,0) since the equalized signal q(n) should have the best reliability. Please refer back to FIG. 2, a stronger echo, as compared with the main path which typically falls in the FE section 202, in the DFE section 204 is more like to suffer from the error propagation. Therefore, the information of the strengths of the echo and main path can acts as a channel quality indicator. In other words, the channel quality indicator Q_{c} is detected in accordance with a maximal magnitude, denoted by C_{FE}, of the forward equalizer coefficients and a second maximal magnitude, denoted by C_{DFE}, of the decision feedback equalizer coefficients. The channel quality indicator Q_{c} is set to be HIGH if a ratio of C_{FE} and C_{DFE} is greater than a preset threshold Θ_{H}. The channel quality indicator Q_{c} is set to be LOW if the ratio is less than another preset threshold Θ_{L}. Otherwise, the channel quality indicator Q_{c} is set to be MIDDLE.

By choosing a value with better reliability, which is a linear combination of the equalized signal, the quantized signal, and the second decoded signal with weighting coefficients adaptable according to the channel quality, for the i^{th} register, whose associated DFE coefficient has the maximal magnitude, the error propagation in the DFE can be effectively reduced. As for the way to set the values of the remanding registers in the DFE, it can be the conventional one. As is well known in the art, these values can be set based on the quantized signal d′(n), or even the second decoded signal p′(n). Another way to set the values of the remanding registers in the DFE is to feed the output signal of the summing unit 512 in calculating unit 500 or calculating unit 600 to the DFE 104. These registers 1042 in the DFE 104 are shift registers. For the calculating unit 500, the output of the summing unit 512 is fed to the h^{th} shift register in the DFE 104. For the calculating unit 600, the output of the summing unit 512 is fed to the first shift register in the DFE 104. As time elapses, the value generated by summing unit 512 will be definitely shifted to the i^{th} register, thereby the spirit of the invention is achieved.

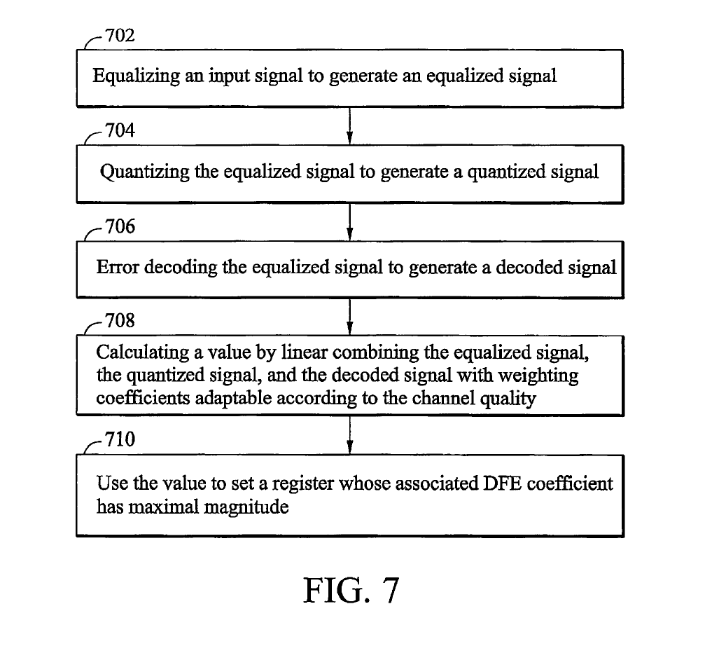

FIG. 7 is a flowchart of the method for reducing the error propagation in a decision feedback equalizer according to the embodiment of the invention. In step 702, an input signal is equalized by an equalizer comprising a forward equalizer (FE) and a decision feedback equalizer (DFE) to form an equalized signal. In step 704, the equalized signal is quantized to form a quantized signal. In step 706, the equalized signal is decoded by a error correction decoder to form a decoded signal. In step 708, a value is calculated by linear combining the equalized signal, the quantized signal, and the decoded signal with weighting coefficients adaptable according to the channel quality. In step 710, the value is used to set a register whose associated DFE coefficient has maximal magnitude. While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An apparatus for reducing error propagation in a receiver comprising:
a forward equalizer, receiving and storing an input signal in a first plurality of registers, and generating a first equalized signal based on the values stored in the first plurality of registers and a plurality of associated forward equalizer coefficients;
a decision feedback equalizer, generating a second equalized signal based on the values stored in a second plurality of registers and a plurality of associated decision feedback equalizer coefficients;
an adder, summing the first and second equalized signals and generating a third equalized signal;
a quantizer, receiving the third equalized signal and producing a quantized signal;
an error correction decoder, receiving the third equalized signal and producing a decoded signal; and
a calculating unit, calculating a combined value for setting a register in the second plurality of registers whose associated decision feedback equalizer coefficient has maximal magnitude among the plurality of decision feedback equalizer coefficients,
wherein the combined value is obtained according to the third equalized signal, the quantized signal, and the decoded signal.

2. The apparatus as claimed in claim 1 wherein the combined value is a linear combination of the third equalized signal, the quantized signal, and the decoded signal with three weighting coefficients, which are non-negative numbers having a sum of 1.

3. The apparatus as claimed in claim 2 wherein the weighting coefficients are adapted according to a channel quality indicator, which provides information on the quality of a transmission channel.

4. The apparatus as claimed in claim 3 wherein the channel quality indicator is obtained according to a first maximal magnitude of the forward equalizer coefficients and a second maximal magnitude of the decision feedback equalizer coefficients.

5. The apparatus as claimed in claim 4 wherein the channel quality indicator is obtained according to a ratio of the first maximal magnitude to the second maximal magnitude.

6. The apparatus as claimed in claim 1 wherein the error correction decoder is a Viterbi decoder.

7. The apparatus as claimed in claim 1 wherein the quantizer is a slicer.

8. An apparatus for reducing error propagation in a receiver comprising:
a forward equalizer, receiving and storing an input signal in a first plurality of registers, and generating a first equalized signal based on the values stored in the first plurality of registers and a plurality of associated forward equalizer coefficients;
a decision feedback equalizer, generating a second equalized signal based on the values stored in a second plurality of registers and a plurality of associated decision feedback equalizer coefficients;
an adder, summing the first and second equalized signals and generating a third equalized signal;
a quantizer, receiving the third equalized signal and producing a quantized signal; and
a calculating unit, calculating a combined value for setting a register in the second plurality of registers whose associated decision feedback equalizer coefficient has maximal magnitude among the plurality of decision feedback equalizer coefficients,
wherein the combined value is obtained according to the third equalized signal, the quantized signal.

9. The apparatus as claimed in claim 8 wherein the combined value is a linear combination of the third equalized signal and the quantized signal with two weighting coefficients, which are non-negative numbers having a sum of 1.

10. The apparatus as claimed in claim 9 wherein the weighting coefficients are adapted according to a channel quality indicator, which provides information on the quality of a transmission channel.

11. The apparatus as claimed in claim 10 wherein the channel quality indicator is obtained according to a first maximal magnitude of the forward equalizer coefficients and a second maximal magnitude of the decision feedback equalizer coefficients.

12. The apparatus as claimed in claim 11 wherein the channel quality indicator is obtained according to a ratio of the first maximal magnitude to the second maximal magnitude.

13. The apparatus as claimed in claim 8 wherein the quantizer is a slicer.

14. An error propagation reduction method in an equalizer comprising a forward equalizer and a decision feedback equalizer comprising:
equalizing an input signal to generate an equalized signal;
quantizing the equalized signal to generate a quantized signal;
error decoding the equalized signal to generate a decoded signal;
calculating a value by linear combining the equalized signal, the quantized signal, and the decoded signal with weighting coefficients adaptable according to the channel quality; and
using the value to set a register whose associated decision feedback equalizer coefficient has maximal magnitude.

15. The error propagation reduction method as claimed in claim 14 wherein the channel quality indicator is obtained according to a ratio of a first maximal magnitude of a plurality of forward equalizer coefficients to a second maximal magnitude of a plurality of decision feedback equalizer coefficients.
